(19) United States
(12) Patent Application Publication
(10) Pub. No.: US 2025/0205695 A1
(43) Pub. Date: Jun. 26, 2025

(54) HYDROTREATING CATALYST FOR REMOVAL OF CONTAMINANTS FROM HYDROPROCESSING FEEDS

(71) Applicant: UOP LLC, Des Plaines, IL (US)

(72) Inventors: Rishabh Jain, Buffalo Grove, IL (US); Quyen Vu, Buffalo Grove, IL (US); Lixiao Zeng, Chicago, IL (US); Anisha Chakrabarti Erekson, ARLINGTON HEIGHTS, IL (US); Joseph Kozlowski, Brookfield, IL (US)

(21) Appl. No.: 18/981,566

(22) Filed: Dec. 15, 2024

Related U.S. Application Data
(60) Provisional application No. 63/613,040, filed on Dec. 20, 2023.

(51) Int. Cl. B01J 37/02; B01J 21/04; B01J 23/883; B01J 27/19; B01J 37/28; C10G 45/08

(52) U.S. Cl. CPC B01J 37/0203; B01J 21/04; B01J 23/883; B01J 27/19; B01J 37/0236; B01J 37/28; C10G 45/08

(57) ABSTRACT

A hydroprocessing catalyst is provided that is made with an organic acid, such as tartaric acid, that provides for an improved capacity for removal of silicon from hydrocarbon feeds. The silicon acts as a poison to the catalyst when not removed. The catalyst has more available hydroxyl sites than catalysts made using other impregnation liquids besides tartaric acid.

### BACKGROUND OF THE INVENTION

The invention relates to removal of silicon from hydrocarbon feeds. Petroleum feeds need to be treated for the removal of impurities that tend to inactivate catalysts. In particular, it has been found that some metals are poisons to the operation of catalysts. In addition, silicon is a frequently found catalyst poison in hydroprocessing units. Silicon species adsorb on the catalyst surface by forming a strong bond with the alumina (hydroxyl sites) on the catalyst. These bonds reduce the amount of active sites which impacts the hydrotreating activity and leads to deactivation of the downstream catalysts.

### SUMMARY OF THE INVENTION

It has been found that a hydroprocessing catalyst made by a process comprising impregnating a composition comprising about 1-20 wt % Group VIB metal oxide, 1-10 wt % Group VIIIB metal oxide, and 1-10 wt % a Group Va oxide with an impregnating solution containing at least one organic acid is effective in removal of silicon from hydrocarbon feeds. In particular, when the organic acid has at least two carboxylic groups, it is effective in removing silicon which is a catalyst poison. Tartaric acid is a preferred organic acid to be used in preparation of the catalysts by this process.

### BRIEF DESCRIPTION OF THE DRAWINGS

FIG. 1 shows the reaction of silica species from the feed with hydroxyl sites on the alumina surface.

FIG. 2 shows the FTIR spectra of catalyst samples prepared to compare degree of attenuation of hydroxyl groups based on impregnation solution.

FIG. 3 shows the Raman spectra of catalyst samples with one sample prepared with tartaric acid having a shoulder at about 996 cm⁻¹ which is not visible with other samples.

### DETAILED DESCRIPTION OF THE INVENTION

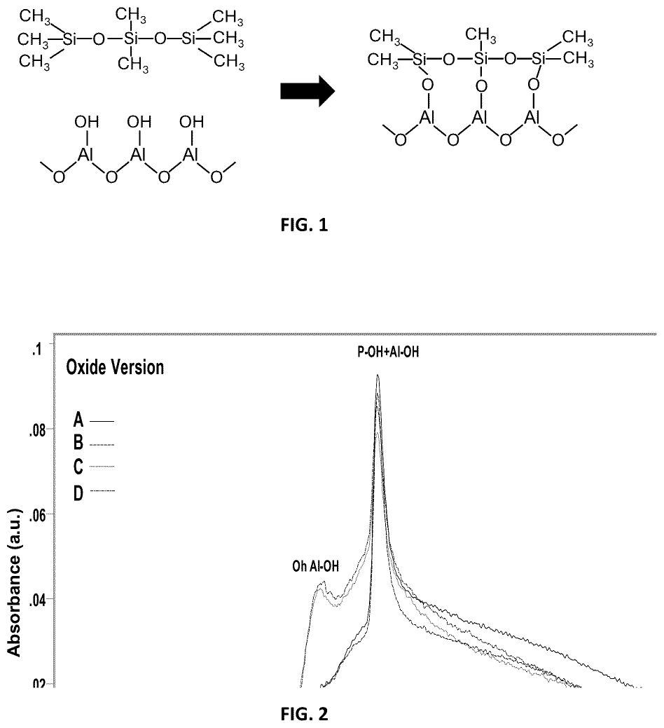

Specifically, it has been found that the use of certain organic acids during the impregnation of metals onto the catalyst support produces a catalyst more capable of removing silicon from petroleum feeds. In particular, it has been found that the use of tartaric acid (TA) during the metal (Ni and Mo) impregnation on the alumina support is advantageous in the removal of silicon. Citric acid (CA) and phosphorus can also be utilized. Phosphorous also adsorbs onto the hydroxyl sites on the alumina surface consuming sites that could be utilized for silicon adsorption. Organic acids such as citric acid and tartaric acid are assumed to be vaporized during either the catalyst finishing or sulfiding process, leaving hydroxyl sites available for silicon pickup. Based on this hypothesis, citric acid and tartaric acid were tried but only tartaric acid provided increased silicon pickup. It may be that tartaric acid evaporates “cleanly” while citric acid evaporates into carbon species that may have formed coke on the hydroxyl sites. This was corroborated by FTIR analysis of calcined forms using tartaric acid and citric acid versions. Oxide forms have similar hydroxyl population while after calcination tartaric acid provided higher hydroxyl sites than citric acid. CHN analysis shows calcined tartaric acid version has <0.05 wt % carbon (below the detection limit) while calcined citric acid version has 0.2 wt % carbon left on the catalyst. In FIG. 1 may be seen the reaction of silica containing species with the hydroxyl sites on the alumina surface.

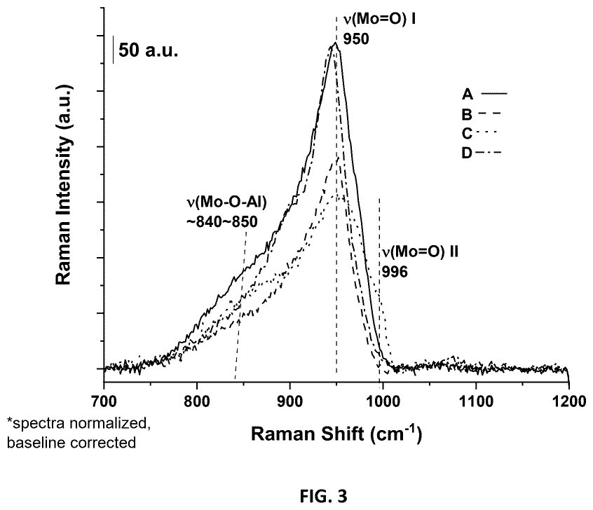

To dissolve metals in the impregnation solution, acids are required. Phosphoric acid can be utilized, which also improves hydrotreating activity. In the application of the catalyst as a silicon trap, hydroxyl sites need to be free for the pickup of silicon species. If the phosphorus impregnated catalyst with metal levels Ni/Mo 2.7/8 is considered as base case. Silicon pickup can be increased by either decreasing the metal and phosphorus levels or replacing phosphorus by organic acids as attenuation of hydroxyl sites decreases through these two pathways. The disadvantages of decreasing metal level are there is a debit on the hydrotreating activity, and the overall catalyst density decreases due to this improvement in Si pickup per volume basis as compared to base case is not much. Thus, using tartaric acid provides an alternate pathway to dissolve molybdenum in the impregnation solution and improves the silicon pickup both on weight and volume basis, since the same metal levels can be maintained. Note that a minimum phosphorus level is necessary to ensure molybdenum solubility. The catalyst sampled prepared through tartaric acid impregnation pathway shows a shoulder at ˜996 cm⁻¹ in a Raman spectrum which is unique to the tartaric acid impregnation route and has not been observed for other samples. Origin of this peak may be due to the tartaric acid version catalyst having a better silicon pickup performance than a citric acid version. About 0.5 wt % anatase was physically mixed into each sample to create an internal standard. FIG. 3 shows the Raman spectra of different catalyst samples.

The catalyst has a Raman spectrum with a shoulder at ˜996 cm−1. Raman spectra were collected on a Horiba LabRam HREvolution spectrometer in backscatter configuration equipped with a 532 nm laser, 600 grooves/mm diffraction grating, 10× objective lens, and confocal microscope. Spectra were collected of multiple spots in the 100-1200 cm⁻¹ Raman shift range. To allow for quantitative analysis, ˜0.5 wt % of anatase titania was physically mixed with the samples to create an internal standard for spectral normalization. Spectra were collected using the Horiba software LabSpec 6. All data analysis, including averaging, smoothing, and normalization, were performed in OriginPro 2022.

The preparation of the catalyst is an aspect of the invention. More precisely the subject of the invention is a process for the preparation of a catalyst from a catalytic precursor comprising a support based on alumina and/or silica-alumina and/or zeolite and comprising at least one element of group VIB and optionally at least one element of group V111, said process comprising impregnation of said precursor with a solution of an organic acid such as tartaric acid, characterized in that it comprises the impregnation of a dried, calcined or regenerated precursor with at least one solution containing at least one carboxylic acid, then maturing and drying at a temperature lower than 200° C., possibly followed by a heat treatment at a temperature lower than 350° C., preferably lower than 300° C., the catalytic precursor solution usually contains phosphorus.

A method is provided of preparing a hydrotreating catalyst comprising 1-20 wt % and preferably 5-15 wt % of a Group VIB metal oxide, 1-10 wt %, preferably 1-5 wt % of a Group VIIIB metal oxide, 1-10 wt %, preferably 1-5 wt % of a Group Va oxide, where an impregnating solution is used which contains at least one organic acid that is generally a carboxylic acid comprising at least one carboxyl group and 1-20 carbon atoms (carbon atoms in the carboxyl group included). Other similar molecules besides organic acids may be used such as aldehydes and ketones, but they are much less preferable. Suitable organic acids include acetic acid, citric acid, malic acid, maleic acid, formic acid, glycolic acid, hydroxypropionic acid, hydroxybutyric acid, hydroxyhexanoic acid, tartaric acid, glyceric acid, gluconic acid, oxalic acid, malonic acid, and ascorbic acid, etc. Within this group of acids, organic acids such as tartaric acid comprising at least two carboxylic groups are preferred. The preferred organic acids that burn off cleanly from the catalyst are preferred as this has been found to be enabling higher hydroxyl sites on catalyst surface leading to higher contaminant pickup. This is measured from the FTIR spectra of dried vs calcined sample where tartaric acid version retains higher hydroxyl sites than citric acid version. Hydroxyl groups are quantified based on integration of spectra in the region 3825-3200 cm−1.

The FTIR spectra were collected on a Thermo Nicolet iS50 instrument. The powdered samples were pressed into 13 mm diameter self-supporting pellets of ˜10 mg for transmission FTIR experiments. Spectra were collected using 512 scans, 2 cm⁻¹ resolution, moderate attenuation, in the 700-5000 cm⁻¹ range. All spectral analysis was carried out in GRAMS AI software. All FTIR spectra were normalized to the pellet weight, truncated, baseline corrected, then truncated to the hydroxyl region and baseline corrected again in the hydroxyl region. To obtain the available hydroxyl concentrations, the FTIR spectra were integrated in the hydroxyl region (3825-3200 cm⁻¹). To calculate the hydroxyl content consumed by metals deposition in the finished catalyst, the FTIR spectrum of the finished catalyst was subtracted from the FTIR spectrum of the related base with no metals present. The subtracted FTIR spectrum was integrated in the hydroxyl region (3825-3200 cm⁻¹). FIG. 2 shows FTIR spectra of catalyst samples prepared by impregnating metal solutions on the support DHT-8036 (A) by IWI. Depending upon the impregnation solution, varying degree of attenuation of hydroxyl groups is achieved. (B-D) as metal (Ni and Mo) and phosphorus (P) levels decrease, more hydroxyl sites are achieved. (E-F) By replacing phosphorus by tartaric acid or citric acid at same metal levels, similar increment in hydroxyl sites is observed.

A preferred amount of organic acid is adjusted to solubilize metals in the impregnation solution, such as molar ratio organic acid/Group VIIIB metal oxide, is at least 0.5. The finished catalyst is obtained by drying the catalyst after metal impregnation. The drying temperature is selected to minimize organic acid decomposition.

The silica species will be attracted to available hydroxyl sites on the alumina surface of the catalyst used in this disclosure.

This disclosure involves using an organic acid such as tartaric acid in the metal impregnation solution with tartaric acid/Ni molar ratio being 1. Metal impregnation was done through incipient wetness. With molybdenum source as molybdenum trioxide and nickel as nickel carbonate. With molybdenum source as molybdenum trioxide and nickel as nickel carbonate. Target metal composition of catalyst in terms of oxides: MoO3 1-20 wt % NiO 1-10 wt % and P₂O₅ 1-10 wt %.

To achieve this result an impregnation solution was prepared by adding the desired amount of tartaric acid to deionized water followed by the addition of nickel carbonate. Then phosphoric acid (H₃PO₄) was added until all solids were dissolved in the solution. Solution temperature was raised to 85° C. After bubbling subsided, molybdenum trioxide was added. The slurry was mixed at 120 RPM until foaming subsided. The solution was further heated for 3 hours at 93° C.

The table shows the hydrotreating activity (hydrodenitrogenation (HDN) and hydrodesulfurization (HDS) and silicon pickup of different version of Si trap catalysts. The tartaric acid version shows higher Si pickup (on wt. and vol. basis) while maintaining hydrotreating activity on a similar level to the base case.

TABLE

| | | | | | | | Si pickup | Si pickup |
|---|---|---|---|---|---|---|---|---|
| | | | | | | | (wt % of | (vol of |
| | | | | Median | | | fresh | fresh |
| | | | Surface | pore | | | catalyst | catalyst |
| Sample | Catalyst | Metals | area | diameter | HDN | HDS | loaded | loaded |
| label | version | (wt %) | (m²/g)^{a} | (Å)^{b} | RVA^{c, d} | RVA^{c, d} | basis)^{c} | basis)^{c} |
| A | Base case | Ni/Mo/P | 200 | 89 | 100 | 100 | 9.2 | 58.0 |
| | | 2.7/8/2 | | | | | | |
| | | 60% of | | | | | | |
| | | base | | | | | | |
| B | Low | (Ni/Mo/P | 214 | 87 | 79 | 95 | 10.3 | 57.1 |
| | metal | 1.6/4.8/1.2) | | | | | | |
| C | Tartaric | Ni & Mo | 221 | 85 | 88 | 102 | 10.0 | 62.4 |
| | acid | same as | | | | | | |
| | | base; P | | | | | | |
| | | 0.5 | | | | | | |
| D | Citric | Ni & Mo | 221 | 83 | 99 | 98 | 8.3 | 53.2 |
| | acid | same as | | | | | | |
| | | base; P | | | | | | |
| | | 0.5 | | | | | | |

^{a}From SURFACE AREA U964
^{b}From MERCURY POROSIMETRY U578
^{c}From pilot plant tests performed at 2000 psig, 3000 SCFB, 710° F. For HDN and HDS, LHSV is 3.8 hr⁻¹. Si pickup is measured at LHSV 10-30 hr⁻¹. Feed is VGO blended with silicon dopant (cyclohexasiloxane).
^{d}Hydrotreating activity on volume basis

TGA-MS studies showed that samples that are impregnated using tartaric acid solution show only carbon dioxide and water being evolved during calcination. This contrasts to samples that are impregnated with citric acid showing some other species besides carbon dioxide and water being evolved. Analysis was done on a TA Discovery TGA with a MKS MS attached. Approximately 40 mg of as received catalyst was used for analysis. The test method consisted of a temperature ramp of 50° C./min to 400° C. under a flow of 45 mL/min of 20% 02/He.

The surface area and median pore diameter analysis shown in the above table is for determining the surface area (SA), total pore volume (PV), average pore diameter (PD), and pore size distribution from 2 to approximately 60 nm (20 to 600 angstroms) of porous materials. The method describes the standard procedure for analysis, data collection and reporting using a commercially available instrument.

Outline of Method: The sample is degassed using heat and vacuum. After weighing, it is cooled in liquid nitrogen. The amount of nitrogen gas adsorbed on the sample is measured at various predetermined pressures. The instrument computer processes the data and calculates surface area, total pore volume, average pore diameter, and pore size distribution based on the isotherm. The results are printed and/or plotted as desired.

### Specific Embodiments

While the following is described in conjunction with specific embodiments, it will be understood that this description is intended to illustrate and not limit the scope of the preceding description and the appended claims.

A first embodiment of the invention is a method preparing a hydroprocessing catalyst comprising impregnating a composition comprising about 1-20 wt % Group VIB metal oxide, 1-10 wt % Group VIIIB metal oxide, and 1-10 wt % a Group Va oxide with an impregnating solution containing at least one organic acid. An embodiment of the invention is one, any or all of prior embodiments in this paragraph up through the first embodiment in this paragraph wherein the organic acid is selected from the group consisting of acetic acid, citric acid, malic acid, maleic acid, formic acid, glycolic acid, hydroxypropionic acid, hydroxybutyric acid, hydroxyhexanoic acid, tartaric acid, glyceric acid, gluconic acid, oxalic acid, malonic acid, and ascorbic acid. An embodiment of the invention is one, any or all of prior embodiments in this paragraph up through the first embodiment in this paragraph wherein the organic acid comprises at least two carboxylic groups. An embodiment of the invention is one, any or all of prior embodiments in this paragraph up through the first embodiment in this paragraph wherein the organic acid is tartaric acid. An embodiment of the invention is one, any or all of prior embodiments in this paragraph up through the first embodiment in this paragraph wherein the composition comprises 5-15 wt % Group VIB metal oxide. An embodiment of the invention is one, any or all of prior embodiments in this paragraph up through the first embodiment in this paragraph wherein the composition comprises 1-5 wt % Group VIIIB metal oxide. An embodiment of the invention is one, any or all of prior embodiments in this paragraph up through the first embodiment in this paragraph wherein the composition comprises 1-5 wt % Group Va oxide. An embodiment of the invention is one, any or all of prior embodiments in this paragraph up through the first embodiment in this paragraph wherein the organic acid burns off cleanly from an impregnated catalyst. An embodiment of the invention is one, any or all of prior embodiments in this paragraph up through the first embodiment in this paragraph wherein a molar ratio of said organic acid to said Group VIIIB metal oxide is at least about 0.5. An embodiment of the invention is one, any or all of prior embodiments in this paragraph up through the first embodiment in this paragraph wherein the hydroprocessing catalyst is dried after said impregnation at a temperature selected to minimize organic acid decomposition.

A second embodiment of the invention is a method of preparing a hydroprocessing catalyst comprising impregnating a composition comprising about 1-20 wt % Group VIB metal oxide, 1-10 wt % Group VIIIB metal oxide, and 1-10 wt % a Group Va oxide with an impregnating solution containing at least tartaric acid or citric acid. The method of claim 11 wherein the Group VIB metal oxide comprises molybdenum. An embodiment of the invention is one, any or all of prior embodiments in this paragraph up through the first embodiment in this paragraph wherein the Group VIIIB metal oxide comprises nickel or cobalt.

A third embodiment of the invention is a process of removing silicon from a hydrocarbon composition comprising contacting said hydrocarbon composition with a hydroprocessing catalyst made by impregnating a composition comprising about 1-20 wt % Group VIB metal oxide, 1-10 wt % Group VIIIB metal oxide, and 1-10 wt % a Group Va oxide with an impregnating solution containing at least one organic acid followed by drying said hydroprocessing catalyst. An embodiment of the invention is one, any or all of prior embodiments in this paragraph up through the first embodiment in this paragraph wherein the organic acid is tartaric acid.

1. A method of preparing a hydroprocessing catalyst comprising impregnating a composition comprising about 1-20 wt % Group VIB metal oxide, 1-10 wt % Group VIIIB metal oxide, and 1-10 wt % a Group Va oxide with an impregnating solution containing at least one organic acid.

2. The method of claim 1 wherein said organic acid is selected from the group consisting of acetic acid, citric acid, malic acid, maleic acid, formic acid, glycolic acid, hydroxypropionic acid, hydroxybutyric acid, hydroxyhexanoic acid, tartaric acid, glyceric acid, gluconic acid, oxalic acid, malonic acid, and ascorbic acid.

3. The method of claim 1 wherein said organic acid comprises at least two carboxylic groups.

4. The method of claim 1 wherein said organic acid is tartaric acid.

5. The method of claim 1 wherein said composition comprises 5-15 wt % Group VIB metal oxide.

6. The method of claim 1 wherein said composition comprises 1-5 wt % Group VIIIB metal oxide.

7. The method of claim 1 wherein said composition comprises 1-5 wt % Group Va oxide.

8. The method of claim 1 wherein said organic acid burns off cleanly from an impregnated catalyst.

9. The method of claim 1 wherein a molar ratio of said organic acid to said Group VIIIB metal oxide is at least about 0.5.

10. The method of claim 1 wherein said hydroprocessing catalyst is dried after said impregnation at a temperature selected to minimize organic acid decomposition.

11. A method of preparing a hydroprocessing catalyst comprising impregnating a composition comprising about 1-20 wt % Group VIB metal oxide, 1-10 wt % Group VIIIB metal oxide, and 1-10 wt % a Group Va oxide with an impregnating solution containing at least tartaric acid or citric acid.

12. The method of claim 11 wherein the Group VIB metal oxide comprises molybdenum.

13. The method of claim 11 wherein the Group VIIIB metal oxide comprises nickel or cobalt.

14. A process of removing silicon from a hydrocarbon composition comprising contacting said hydrocarbon composition with a hydroprocessing catalyst made by impregnating a composition comprising about 1-20 wt % Group VIB metal oxide, 1-10 wt % Group VIIIB metal oxide, and 1-10 wt % a Group Va oxide with an impregnating solution containing at least one organic acid followed by drying said hydroprocessing catalyst.

15. The process of claim 1 wherein said organic acid is selected from the group consisting of acetic acid, citric acid, malic acid, maleic acid, formic acid, glycolic acid, hydroxypropionic acid, hydroxybutyric acid, hydroxyhexanoic acid, tartaric acid, glyceric acid, gluconic acid, oxalic acid, malonic acid, and ascorbic acid.

16. The process of claim 14 wherein said organic acid is tartaric acid.

17. The process of claim 14 wherein said composition comprises 5-15 wt % Group VIB metal oxide.

18. The process of claim 14 wherein said composition comprises 1-5 wt % Group VIIIB metal oxide.

19. The process of claim 14 wherein said composition comprises 1-5 wt % Group Va oxide.

20. The process of claim 14 wherein a molar ratio of said organic acid to said Group VIIIB metal oxide is at least about 0.5.
